(19) United States
(12) Patent Application Publication
(10) Pub. No.: US 2017/0227784 A1
(43) Pub. Date: Aug. 10, 2017

(54) ELECTROMAGNETIC DRIVING MODULE AND LENS DRIVING DEVICE USING THE SAME

(71) Applicant: TDK TAIWAN CORP., Yangmei Taoyuan (TW)

(72) Inventors: Cheng-Kai YU, Yangmei Taoyuan (TW); Chao-Chang HU, Yangmei Taoyuan (TW)

(21) Appl. No.: 15/421,057

(22) Filed: Jan. 31, 2017

Related U.S. Application Data
(60) Provisional application No. 62/291,311, filed on Feb. 4, 2016.

(30) Foreign Application Priority Data
Nov. 10, 2016 (TW) 105136582

(51) Int. Cl. G02B 27/64; H02K 11/30; H02K 33/12; G02B 7/02; G02B 7/04

(52) U.S. Cl. CPC G02B 27/646; G02B 7/023; G02B 7/04; H02K 33/12; H02K 11/30

(57) ABSTRACT

An electromagnetic driving device is provided which includes a fixed assembly, a movable assembly, and an electromagnetic assembly. The fixed assembly and the movable assembly are arranged along a main axis. The fixed assembly has a surface that faces the movable assembly. The electromagnetic assembly is configured to drive the movement of the movable assembly relative to the fixed assembly. As observed from a direction that is perpendicular to the main axis, a portion of the movable assembly overlaps the plane on which the surface of the fixed assembly is located while the movable assembly is moved a portion of a path of travel.

### CROSS REFERENCE TO RELATED APPLICATIONS

This application claims priority of Taiwan Patent Application No. 105136582, filed on Nov. 10, 2016, and U.S. Provisional Patent Application No. 62/291,311, filed on Feb. 4, 2016, the entirety of which are incorporated by reference herein.

### BACKGROUND

Field of the Invention

The present invention relates to a driving module and a lens driving device using the same, and more particularly to an electromagnetic driving module which converts electrical energy into mechanical energy, and a lens driving device using the same.

Description of the Related Art

Some electronic devices are equipped with a driving module to drive an element to move a predetermined distance. For example, a lens driving device in a camera usually includes a driving module to generate motive power. One or more optical lens units of the lens driving device are driven by the motive power to move along a direction perpendicular to the optical axis, so as to facilitate image stabilization.

However, since the driving module includes a complex driving member, such as a stepper motor, ultrasonic motor, piezoelectric actuator, etc. to generate the motive power, and the motive power has to be transmitted by a number of transmission elements, it is not easy to assemble and the manufacturing cost is high. In addition, a conventional driving module is also large in size and has high power consumption due to its complex construction.

On the other hand, when an external force or excessive movement impacts the movable assembly, the movable assembly may collide with the fixed assembly, thereby causing the component to be damaged. In a known drive module, the distance between the movable assembly and the fixed assembly is generally increased to avoid collisions between the movable assembly and the fixed assembly. However, it does not conform to the design trend of reducing the thickness of the drive module.

### SUMMARY

In order to address the drawbacks of the prior art, one objective of the disclosure is to provide an electromagnetic drive module having less thickness and preventing or avoiding collisions between the movable assembly and the fixed assembly.

In accordance with some embodiments of the disclosure, the electromagnetic driving module includes a movable assembly, a fixed assembly and an electromagnetic assembly. The fixed assembly is arranged on a main axis with the fixed assembly. The fixed assembly has a surface facing the movable assembly. The electromagnetic assembly is configured to drive the movement of the movable assembly relative to the fixed assembly using magnetic force. As observed from a direction that is perpendicular to the main axis, a portion of the movable assembly that is closer to the main axis than the fixed assembly overlaps the plane on which the surface of the fixed assembly is located while the movable assembly is moved a certain portion of the path of travel.

In the above-mentioned embodiments, the fixed assembly comprises a coil substrate, and the movable assembly comprises a magnetic element, and the electromagnetic assembly comprises an OIS driving coil positioned on the coil substrate and facing the magnetic element. The portion of the movable assembly overlaps a plane where the upper surface of the coil substrate is located.

In the above-mentioned embodiments, the coil substrate is penetrated by an opening, and a number of voids are formed on the edge of the opening. The portion of the movable assembly overlaps the voids.

In the above-mentioned embodiments, the fixed assembly comprises a base, and the base and the coil substrate are penetrated by two openings. The width of the opening on the base is smaller than the width of the opening on the coil substrate, and the portion of the movable assembly is located over the base.

In the above-mentioned embodiments, the fixed assembly comprises a circuit board connected to the coil substrate and is positioned farther away from the movable assembly than the coil substrate. The portion of the movable assembly also overlaps the plane on which the upper surface of the circuit board is located.

In the above-mentioned embodiments, the circuit board is penetrated by an opening, and an electric via is formed on the edge of the opening on the circuit board, wherein the electric via is covered by the coil substrate, and a conductive material is positioned in the electric via to electrically connect the circuit board to the coil substrate.

In the above-mentioned embodiments, the fixed assembly comprises a base, and the base is penetrated by an opening. A flange protrudes from the edge of the opening, and a number of grooves are formed on the flange, the portion of the movable assembly is located in the grooves.

In the above-mentioned embodiments, the electromagnetic driving module further comprises a lower flexible assembly fixed on a lower surface of the movable assembly by an engaging material. As observed from a direction that is perpendicular to the main axis, a portion of the engaging material overlaps the plane on which the surface of the fixed assembly is located while the movable assembly is closest to the fixed assembly.

In the above-mentioned embodiments, the electromagnetic assembly comprises a focusing driving coil and a magnetic element. The magnetic element faces the focusing driving coil, and the focusing driving coil and the magnetic element are positioned on the movable assembly. As observed from a direction that is perpendicular to the main axis, a portion of the magnetic element constantly overlaps the plane on which the surface of the fixed assembly is located while the movable assembly is moved along the path of travel.

Another objective of the disclosure is to provide a lens driving device including the electromagnetic driving module in any one of the above-mentioned embodiments. The lens driving device further includes a lens assembly positioned on the movable assembly of the electromagnetic driving module. The optical axis of the lens assembly is aligned with the main axis.

### BRIEF DESCRIPTION OF THE DRAWINGS

For a more complete understanding of the embodiments and the advantages thereof, reference is now made to the following descriptions taken in conjunction with the accompanying drawings.

FIG. 1 shows an exploded view of an electromagnetic driving module, in accordance with some embodiments of the disclosure.

FIG. 2 shows a cross-sectional view of an electromagnetic driving module, in accordance with some embodiments of the disclosure.

FIG. 3 shows a cross-sectional view of an electromagnetic driving module as a movable assembly is moved toward a fixed assembly, in accordance with some embodiments of the disclosure.

FIG. 4 shows an exploded view of an electromagnetic driving module, in accordance with some embodiments of the disclosure.

FIG. 5 shows an exploded view of partial elements of an electromagnetic driving module, in accordance with some embodiments of the disclosure.

FIG. 6 shows a cross-sectional view of an electromagnetic driving module, in accordance with some embodiments of the disclosure.

FIG. 7 shows a cross-sectional view of an electromagnetic driving module as a movable assembly is moved toward a fixed assembly, in accordance with some embodiments of the disclosure.

### DESCRIPTION OF THE ILLUSTRATIVE EMBODIMENTS

In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments.

It should be noted that the elements or devices in the drawings of the present disclosure may be present in any form or configuration known to those skilled in the art. In addition, the expression “an element overlying another element”, “an element is disposed above another element”, “an element is disposed on another element” and “an element is disposed over another element” may indicate that the element directly contacts the other element, or it may indicate that the element does not directly contact the other element, there being one or more intermediate elements disposed between the element and the other element.

In this specification, relative expressions are used. For example, “lower”, “bottom”, “higher” or “top” are used to describe the position of one element relative to another. It should be appreciated that if a device is flipped upside down, an element at a “lower” side will become an element at a “higher” side.

The terms “about” and “substantially” typically mean +/−20% of the stated value, more typically +/−10% of the stated value and even more typically +/−5% of the stated value. The stated value of the present disclosure is an approximate value. When there is no specific description, the stated value includes the meaning of “about” or “substantially”.

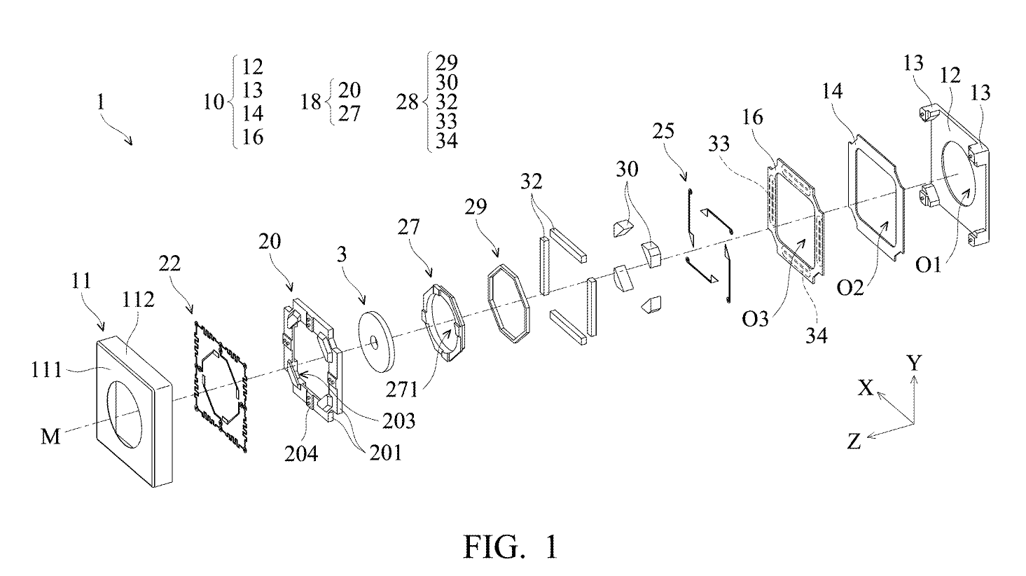

FIG. 1 shows a schematic view of a lens driving device 1, in accordance with some embodiments. In some embodiments, the lens driving device 1 includes an electromagnetic driving module 2 and a lens assembly 3. The electromagnetic driving module 2 is configured to support the lens assembly 3 and to control the movement of the lens assembly 3. In some embodiments, the electromagnetic driving module 2 includes a fixed assembly 10, a housing 11, a movable assembly 18, an upper flexible assembly 22, a lower flexible assembly 25 and an electromagnetic assembly 28. The elements of the electromagnetic driving module 2 can be added to or omitted, and the invention should not be limited by the embodiment.

The housing 11 includes an upper housing member 111 and a lateral housing member 112. The upper housing member 111 has a rectangular shape. The lateral housing member 112 extends from the edges of the upper housing member 111 toward the base 12. The fixed assembly 10 includes a base 12, four positioning pillars 13, a circuit board 14 and a coil substrate 16. The base 12 has a shape that corresponds to the shape of the upper housing member 111. The base 12 is connected to the housing 11 via the lateral housing member 112. The base 12 is penetrated by a circular opening O1, wherein the main axis M passes through the center of the opening O1. The four positioning pillars 13 are positioned at four corners of the base 12 for facilitating the connection of the movable assembly 18.

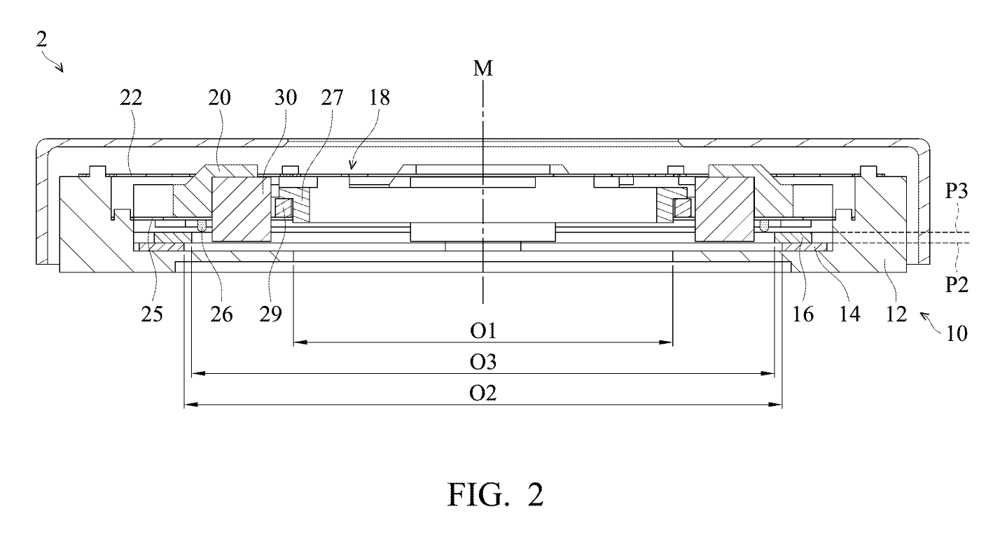

The circuit board 14 is positioned on the base 12 and is configured to electrically connect a control module (not shown in figures) to the electric elements of the electromagnetic driving module 2. The circuit board 14 is penetrated by an opening O2 with a substantially circular shape, wherein the main axis M passes through the center of the opening O2. The coil substrate 16 is positioned on the circuit board 14 and is electrically connected to the circuit board 14. The coil substrate 16 is penetrated by an opening O3 with a substantially circular shape, wherein the main axis M passes through the center of the opening O3. In some embodiments, as shown in FIG. 2, the width of the opening O1 is smaller than the width of the opening O2, and the width of the opening O3 is smaller than the width of the opening O2.

In some embodiments, the base 12, the circuit board 14 and coil substrate 16 are formed integrally. One example of fabricating the integral fixed assembly is disclosed in Taiwan patent application NO. 104138693.

Continuing to refer to FIG. 1, the movable assembly 18 is configured to support the lens assembly 3. In some embodiments, the movable assembly 18 includes a frame 20 and a lens holder 27. The elements of the movable assembly 18 can be added to or omitted, and the invention should not be limited by the embodiment.

The frame 20 includes four lateral frame members 201 surrounding the main axis M and connected to one another. The upper surface and/or the lower surface of each lateral frame member 201 may include a positioning pin for facilitating the positioning of the upper flexible assembly 22 and the lower flexible assembly 25. In addition, the frame 20 further includes four recesses 203. Each recess 203 is formed in the location where the two neighboring lateral frame members 201 are connected to each other.

The lens holder 27 is surrounded by the frame 20, and the lens holder 27 is penetrated by a passage 271 that extends into the main axis M. The lens assembly 3 is disposed in the passage 271. The upper surface and/or the lower surface of the lens holder 27 may include a positioning pin for facilitating the positioning of the upper flexible assembly 22 and the lower flexible assembly 25.

The upper flexible assembly 22 is connected to the side of the lens holder 27 that is adjacent to the upper housing member 111 and extends on a plane that is perpendicular to the main axis M. The lower flexible assembly 25 is connected to the side of the lens holder 27 that is adjacent to the fixed assembly 10. The upper flexible assembly 22 and the lower flexible assembly 25 may have the same configuration or different configurations. In addition, the positions of the upper flexible assembly 22 and the lower flexible assembly 25 can be exchanged.

In some embodiments, as shown in FIG. 2, the upper flexible assembly 22 and the lower flexible assembly 25 are connected to the lens holder 27 and the frame 20 by the engaging material 26. The engaging material 26 may be glue. Alternatively, the engaging material 26 are the positioning pins which are originally formed on the lens holder 27 or the frame 20. In some embodiments, the distance between the engaging material 26 and the main axis M is shorter than the distance between any components of the fixed assembly 10 and the main axis M. Namely, the engaging material 26 is closer to the main axis M than the fixed assembly 10. The positioning pillars are deformed after curing so as to fix the upper flexible assembly 22 and the lower flexible assembly 25 on the lens holder 27 and the frame 20.

Referring to FIG. 1, the electromagnetic assembly 28 is configured to drive the movement of the movable assembly 18 relative to the fixed assembly 10 using magnetic force. In some embodiments, the electromagnetic assembly 28 includes a focusing driving coil 29, a number of focusing magnetic elements, such as four focusing magnetic elements 30, for adjusting the focal length, a number of OIS (optical image stabilization) magnetic elements, such as four OIS magnetic elements 32, for stabilizing the image and a number of OIS driving coils, such as two OIS driving coils 33 and two OIS driving coils 34.

The focusing driving coil 29 is positioned at the outer surface of the lens holder 27 and is electrically connected to the circuit board 14. The OIS driving coils 33 and 34 are positioned on the coil substrate 16 and electrically connected to the circuit board 14 via the trace in the coil substrate 16. In some embodiments, as shown in FIG. 1, the two OIS driving coils 33 are respectively positioned adjacent to two lateral sides of the base 12 that are arranged along the X direction. In addition, the two OIS driving coils 34 are respectively positioned adjacent to two lateral sides of the base 12 that are arranged along the Y direction.

The four focusing magnetic elements 30 are disposed in the recesses 203, and the four OIS magnetic elements 32 are positioned on the bottom surface of the four lateral frame members 201. Being positioned by the frame 20, the four focusing magnetic elements 30 face the corresponding focusing driving coil 29, and the four OIS magnetic elements 32 face the corresponding OIS driving coil 33 or 34.

In some embodiments, as shown in FIG. 2, the portion of the focusing magnetic elements 30 which is adjacent to the bottom surface is located in the opening O3, but is located outside the opening O2. As observed from a direction that is perpendicular to the main axis M, the portion of each focusing magnetic element 30 which is adjacent to its bottom surface overlaps the plane P3 where the upper surface of the coil substrate 16 is located. That is, the focusing magnetic elements 30 penetrate the plane P3. The bottom surface of the focusing magnetic element 30 refers to the surface of the focusing magnetic element 30 that faces the upper surface of the base 12 and is spaced from the base 12 by a distance, and no contact is created therebetween.

It should be appreciated that the position of the focusing magnetic elements 30 should not be limited to the above-mentioned embodiments. In some embodiments, the portion of the focusing magnetic elements 30 which is adjacent to the bottom surface is located in the opening O3 and in the opening O2. As observed from a direction that is perpendicular to the main axis M, the portion of the focusing magnetic elements 30 which is adjacent to the bottom surface overlaps the plane P3 where the upper surface of the coil substrate 16 is located and the overlaps the plane P2 on which the upper surface of the circuit board 14 is located. That is, the focusing magnetic elements 30 penetrate the plane P3 and the plane P2.

The four magnetic elements 30 may be magnets. One magnetic pole of each magnetic element 30, such as the N pole, faces the focusing driving coil 29. The four OIS magnetic elements 32 may be magnets. One magnetic pole of each OIS magnetic element 32, such as the N pole, faces the OIS driving coils 33 or 34. The four magnetic elements 30 and the four OIS magnetic elements 32 may be fixed on the frame 20 by any suitable method such as gluing.

Referring to FIGS. 1 and 2, in the embodiment, a “focusing driving assembly” for driving the movement of the lens holder 27 relative to the frame 20 is composed by the focusing driving coil 29 and the four focusing magnetic members 30. In addition, an “OIS driving assembly” for driving the movement of the movable assembly 18 relative to the fixed assembly 10 is composed by the OIS driving coils 33 and 34 and the four OIS magnetic members 32.

When the electromagnetic driving module 2 is in operation, the control module (not shown in figures) transmits electric current to the OIS driving coils 33 and 34. The magnetic force produced by the OIS driving assembly causes the movable assembly 18 to move in a direction that is perpendicular to the main axis M relative to the fixed assembly 10 so as to keep the optical axis of the lens assembly 3 in alignment with the main axis M.

In addition, to change the focusing position of the lens assembly 3, the control module (not shown in figures) transmits electric current to the focusing driving coil 29. Afterwards, the lens holder 27 is moved in the main axis M relative to the fixed assembly 10 by the magnetic force produced by the focusing driving assembly. It should be noted that the thickness of the lens driving device 1 is reduced because the portion of each focusing magnetic element 30 which is adjacent to the bottom surface thereof overlaps the plane P3. In addition, when lens driving device 1 has the same thickness as the conventional one, the focusing magnetic elements 30 can be made with greater height. As a result, the path of travel of the movable assembly 18 relative to the fixed assembly 10 is increased, and the electromagnetic driving module 2 can be adapted to drive a variety of lens assemblies 3.

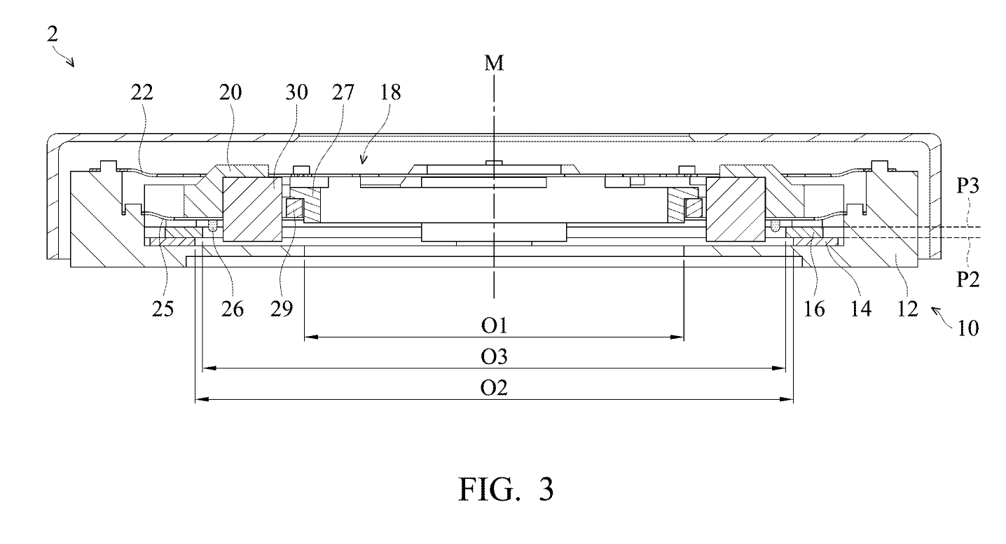

In some embodiments, as observed from a direction that is perpendicular to the main axis M, when the lens holder 27 is moved toward the fixed assembly 10, a portion of the movable assembly 18 overlaps the plane P3 where the upper surface of the coil substrate 16 is located. For example, as shown in FIG. 3, when the lens holder 27 is driven to move toward the fixed assembly 10 by the focusing driving assembly, or the lens holder 27 is moved toward the fixed assembly 10 as a collision occurs, the engaging material 26 overlaps the plane P3 where the upper surface of the coil substrate 16 is located. That is, the engaging material 26 penetrates the plane P3. In some embodiments, the engaging material 26 is located in the opening O3 and the opening O2. Alternatively, the engaging material 26 is located in the opening O3 but is located outside the opening O2. With such arrangements, a collision between the engaging material 26 and the fixed assembly 10 can be prevented, so that no particles are generated, and contamination of the inside of the lens driving device 1 is avoided. Moreover, since the connecting material 26 is not damaged by the collision, the stability of the lens driving device 1 can be increased.

During the operation of the electromagnetic driving module 2, one or more detection assemblies (not shown in the figures) are used to detect changes in the magnetic field of the focusing magnetic elements 30 and/or the OIS magnetic elements 32 and to give feedback on the position of the movable assembly 18 and/or the lens holder 27 relative to the fixed assembly 10 to the control module (not shown in the figures) according to the detected result, so as to establish a closed-loop control.

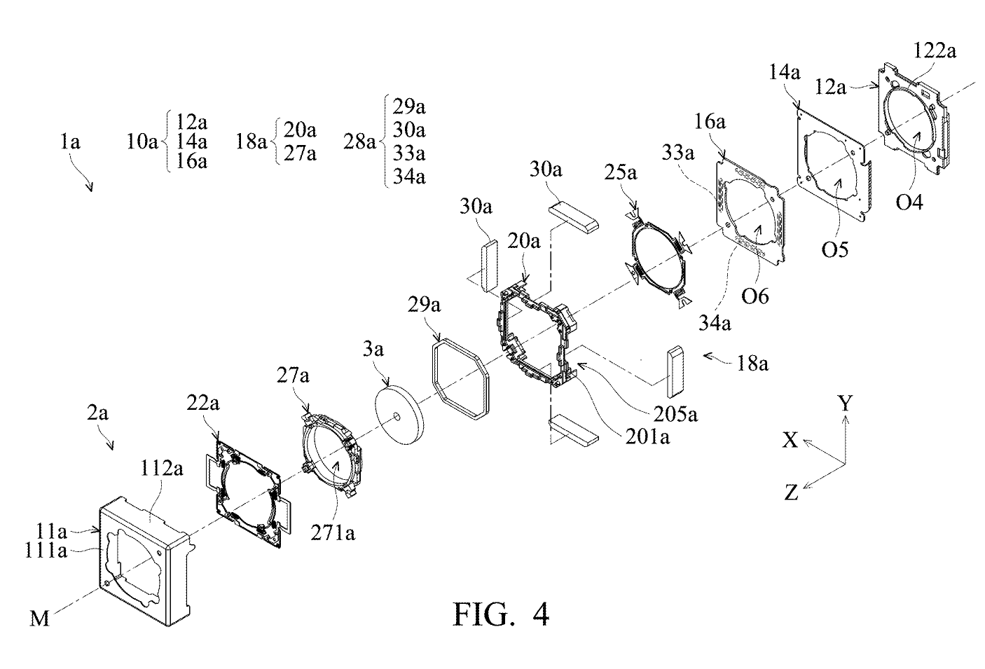

FIG. 4 shows a schematic view of a lens driving device 1a, in accordance with some embodiments. In some embodiments, the lens driving device 1a includes an electromagnetic driving module 2a and a lens assembly 3a. The electromagnetic driving module 2a is configured to support the lens assembly 3a and to control the movement of the lens assembly 3a. In some embodiments, the electromagnetic driving module 2a includes a fixed assembly 10a, a housing 11a, a movable assembly 18a, an upper flexible assembly 22a, a lower flexible assembly 25a and an electromagnetic assembly 28a. The elements of the electromagnetic driving module 2a can be added to or omitted, and the invention should not be limited by the embodiment.

The housing 11a includes an upper housing member 111a and a lateral housing member 112a. The upper housing member 111a has a rectangular shape. The lateral housing member 112a extends from the edges of the upper housing member 111a toward the base 12a. The fixed assembly 10a includes a base 12a, four positioning pillars 13, a circuit board 14a and a coil substrate 16a. The base 12a has a shape that corresponds to the shape of the upper housing member 111a. The base 12a is connected to the housing 11a via the lateral housing member 112a. The base 12a is penetrated by a circular opening O4, wherein the main axis M passes through the center of the opening O4. A flange 122a protrudes from the edge of the opening O4 toward the movable assembly 18a.

The circuit board 14a is positioned on the base 12a and is configured to electrically connect a control module (not shown in figures) to the electric elements of the electromagnetic driving module 2. The circuit board 14a is penetrated by an opening O5 with a substantially circular shape, wherein the main axis M passes through the center of the opening O5. The coil substrate 16a is positioned on the circuit board 14a and is electrically connected to the circuit board 14a. The coil substrate 16a is penetrated by an opening O6 with a substantially circular shape, wherein the main axis M passes through the center of the opening O6.

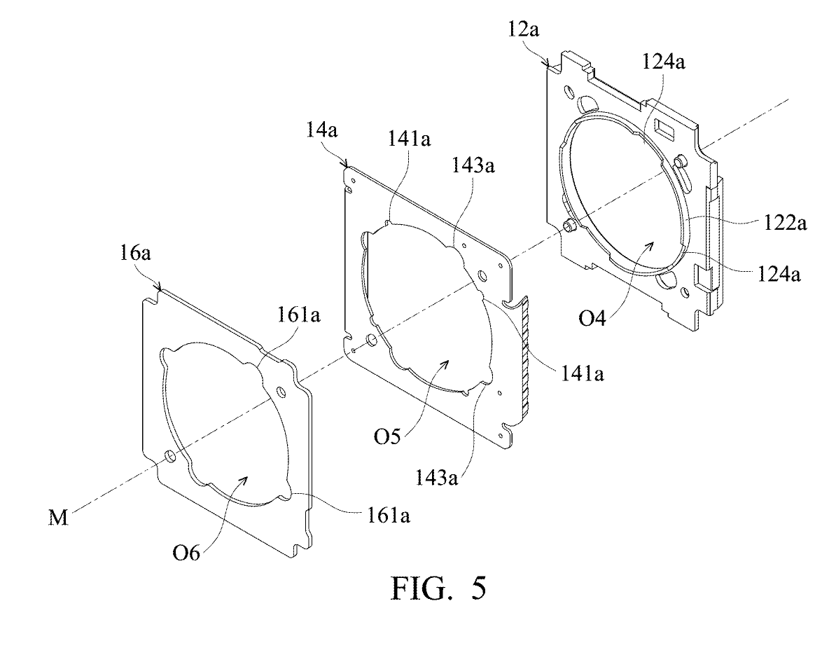

FIG. 5 shows an exploded view of partial elements of an electromagnetic driving module 10a, in accordance with some embodiments of the disclosure. In some embodiments, the width of the opening O5 on the circuit board 14a is greater than the width of the opening O6 on the coil substrate 16a. A number of electric vias 141a are formed on the edge of the opening O5. After assembly of the circuit board 14a and the coil substrate 16a, the electric vias 141a are covered by the lower surface of the coil substrate 16a, and the electric vias 141a are positioned corresponding to the electric contacts (not shown in figures) formed on the coil substrate 16a. The electric vias 141a are electrically connected to the electric contacts formed on the coil substrate 16a by conductive material, such as conductive glue (not shown in the figures).

In addition, a number of voids 161a are formed on the edge of the opening O6, and a number of voids 143a are formed on the edge of the opening O5. The voids 161a communicate with the voids 143a. The number of voids 143a and the dimensions of the voids 143a may respectively correspond to the number of voids 161a and the dimensions of the voids 161a. However, the disclosure should not be limited thereto. The number of voids 143a can be lower the number of voids 161a. Alternatively, the voids 143a are omitted. In some embodiments, the width of the opening O6 on the coil substrate 16a is greater than the width of the opening O4 on the base 12a. The flange 122a of the base 12a is positioned in the opening O5 and in the opening O6. In some embodiments, the base 12a includes a number of grooves 124a which communicate with the voids 161a and/or the voids 143a.

Continuing to refer to FIG. 4, the movable assembly 18a is configured to support the lens assembly 3a. In some embodiments, the movable assembly 18a includes a frame 20a and a lens holder 27a. The elements of the movable assembly 18a can be added to or omitted, and the invention should not be limited by the embodiment.

The frame 20a includes four lateral frame members 201a surrounding the main axis M and connected to one another. Each of the lateral frame members 201a has an accommodation groove 205a for receiving the focusing magnetic elements 30a. The upper surface and/or the lower surface of each lateral frame member 201a may include a positioning pin for facilitating the positioning of the upper flexible assembly 22a and the lower flexible assembly 25a.

The lens holder 27a is surrounded by the frame 20a, and the lens holder 27a is penetrated by a passage 271a that extends into the main axis M. The lens assembly 3a is disposed in the passage 271a. The upper surface and/or the lower surface of the lens holder 27a may include a positioning pin for facilitating the positioning of the upper flexible assembly 22a and the lower flexible assembly 25a.

The upper flexible assembly 22a is connected to the side of the lens holder 27a that is adjacent to the upper housing member 111a and extends on a plane that is perpendicular to the main axis M. The lower flexible assembly 25a is connected to the side of the lens holder 27a that is adjacent to the fixed assembly 10a. The upper flexible assembly 22a and the lower flexible assembly 25a may have the same configuration or different configurations. In addition, the positions of the upper flexible assembly 22a and the lower flexible assembly 25a can be exchanged.

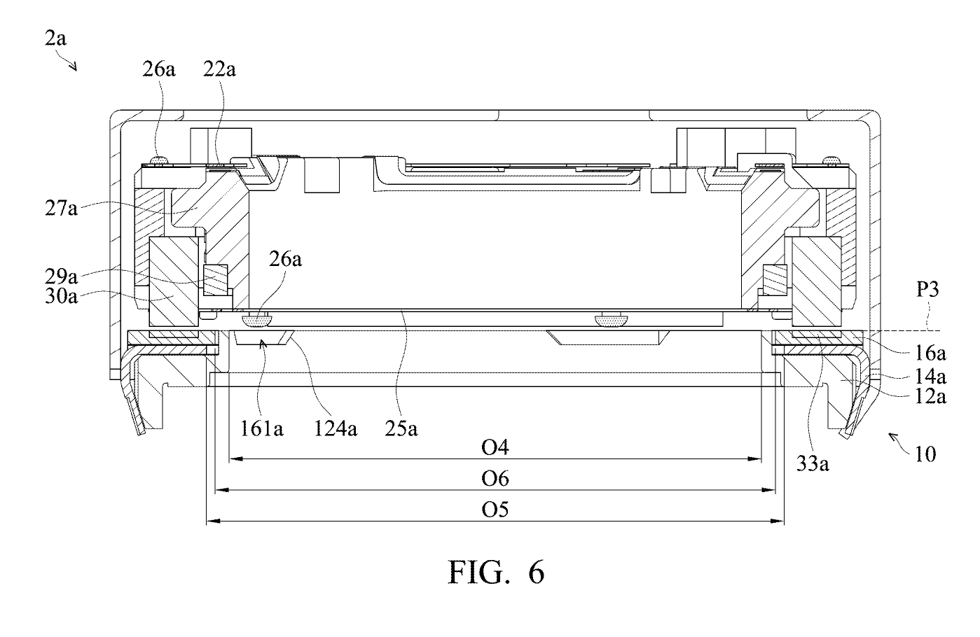

In some embodiments, as shown in FIG. 6, the upper flexible assembly 22a and the lower flexible assembly 25a are connected to the lens holder 27a and the frame 20a by the engaging material 26a. The engaging material 26a may be glue. Alternatively, the engaging material 26a are the positioning pins which are originally formed on the lens holder 27a or the frame 20a. The positioning pins are deformed after curing so as to fix the upper flexible assembly 22a and the lower flexible assembly 25a on the lens holder 27a and the frame 20a.

Referring to FIG. 4, the electromagnetic assembly 28a is configured to drive the movement of the movable assembly 18a relative to the fixed assembly 10a. In some embodiments, the electromagnetic assembly 28a includes a focusing driving coil 29a, a number of focusing magnetic elements 30a and a number of OIS driving coils, such as two OIS driving coils 33a and two OIS driving coils 34a.

The focusing driving coil 29a is positioned at the outer surface of the lens holder 27a and is electrically connected to the circuit board 14a. The OIS driving coils 33a and 34a are positioned on the coil substrate 16a and electrically connected to the circuit board 14a via the traces in the coil substrate 16a. In some embodiments, as shown in FIG. 4, the two OIS driving coils 33a are respectively positioned adjacent to two lateral sides of the base 12a that are arranged along the X direction. In addition, the two OIS driving coils 34a are respectively positioned adjacent to two lateral sides of the base 12a that are arranged along the Y direction.

Referring to FIGS. 4 and 6, four focusing magnetic elements 30a are positioned in the accommodation grooves 205a of the lateral frame members 201a. Being positioned by the frame 20a, the four focusing magnetic elements 30a face the focusing driving coil 29a and the corresponding OIS driving coil 33a or 34a. The four focusing magnetic elements 30a may be positioned on the frame 20a by any suitable method, such as gluing.

When the electromagnetic driving module 2a is in operation, the control module (not shown in figures) transmits electric current to the OIS driving coils 33a and 34a. The magnetic force produced between the focusing magnetic elements 30a and the OIS driving coils 33a and 34a causes the movable assembly 18a to move in a direction that is perpendicular to the main axis M relative to the fixed assembly 10a so as to keep the optical axis of the lens assembly 3a in alignment with the main axis M.

To change the focusing position of the lens assembly 3a, the control module (not shown in figures) transmits electric current to the focusing driving coil 29a. Afterwards, the lens holder 27a is moved in the main axis M relative to the fixed assembly 10a by the magnetic force produced between the focusing magnetic elements 30a and the focusing driving coil 29a.

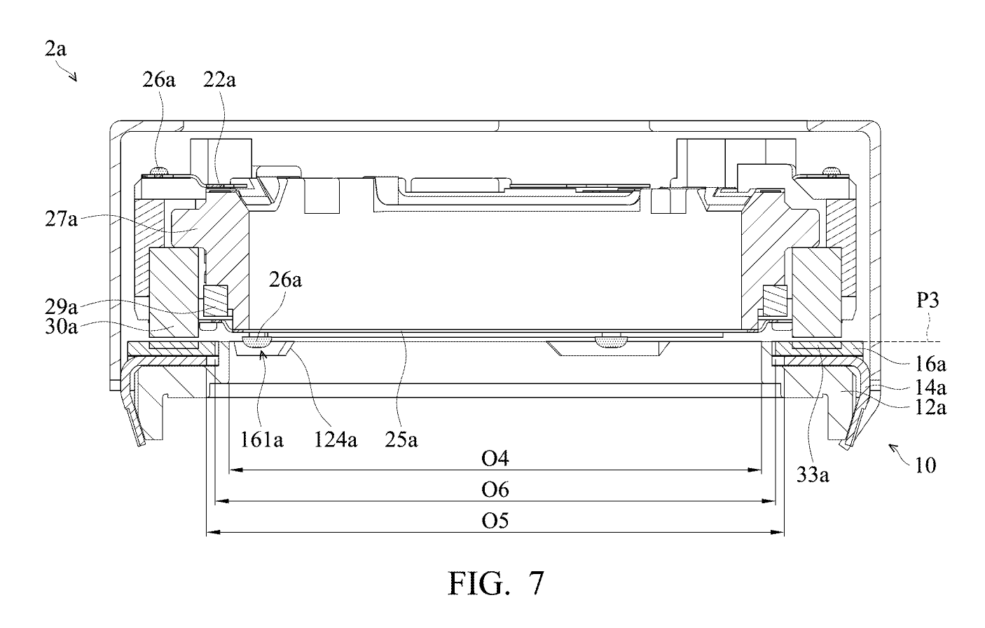

In some embodiments, as observed from a direction that is perpendicular to the main axis M, when the lens holder 27a is moved toward the fixed assembly 10, a portion of the movable assembly 18a overlaps the plane P3 where the upper surface of the coil substrate 16a is located. For example, as shown in FIG. 7, when the lens holder is driven to move toward the fixed assembly 10a by the focusing driving assembly, or the lens holder 27a is moved toward the fixed assembly 10a as a collision occurs, the engaging material 26a overlaps the plane P3 where the upper surface of the coil substrate 16a is located. That is, the engaging material 26a penetrates the plane P3. In some embodiments, the engaging material 26a is located in the voids 161a. That is, as observed from a direction that is perpendicular to the main axis M, a portion of the movable assembly 18a overlaps the voids 161a. In the embodiments of the voids 161a that communicate with the grooves 124a and/or the voids 143a, the engaging material 26a is simultaneously located in the voids 161a, the grooves 124a and the voids 143a. In such arrangements, particles generated due to the impact of the material 26a against the fixed assembly 10a are prevented. In addition, since the connecting material 26a is not damaged by the collision, the stability of the lens driving device 1a can be increased.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An electromagnetic driving module, comprising:
a movable assembly;
a fixed assembly arranged on a main axis with the movable assembly and having a surface facing the movable assembly; and
an electromagnetic assembly configured to drive the movement of the movable assembly relative to the fixed assembly using magnetic force;
wherein as observed from a direction that is perpendicular to the main axis, a portion of the movable assembly that is closer to the main axis than the fixed assembly overlaps a plane on which the surface of the fixed assembly is located while the movable assembly is moved to at least a part of a path of travel.

2. The electromagnetic driving module as claimed in claim 1, wherein the fixed assembly comprises a coil substrate, and the movable assembly comprises a magnetic element, and the electromagnetic assembly comprises an OIS driving coil positioned on the coil substrate and facing the magnetic element,
wherein as observed from the direction that is perpendicular to the main axis, the portion of the movable assembly overlaps a plane where an upper surface of the coil substrate is located.

3. The electromagnetic driving module as claimed in claim 2, wherein the coil substrate is penetrated by an opening, and a plurality of voids are formed on the edge of the opening;
wherein as observed from the direction that is perpendicular to the main axis, the portion of the movable assembly overlaps the voids while the movable assembly is moved to the part of the path of travel.

4. The electromagnetic driving module as claimed in claim 2, wherein the fixed assembly comprises a base, and the base and the coil substrate are penetrated by two openings, wherein the width of the opening on the base is smaller than the width of the opening on the coil substrate, and the portion of the movable assembly is located over the base.

5. The electromagnetic driving module as claimed in claim 2, wherein the fixed assembly comprises a circuit board connected to the coil substrate and is positioned farther away from the movable assembly than the coil substrate;
wherein as observed from the direction that is perpendicular to the main axis, the portion of the movable assembly overlaps a plane where an upper surface of the circuit board is located.

6. The electromagnetic driving module as claimed in claim 5, wherein the circuit board is penetrated by an opening, and an electric via is formed on the edge of the opening on the circuit board, wherein the electric via is covered by the coil substrate, and a conductive material is positioned in the electric via to electrically connect the circuit board to the coil substrate.

7. The electromagnetic driving module as claimed in claim 1, wherein the fixed assembly comprises a base, and the base is penetrated by an opening, wherein a flange protrudes from the edge of the opening, a plurality of grooves are formed on the flange, and the portion of the movable assembly is located in the groove.

8. The electromagnetic driving module as claimed in claim 1, further comprising a lower flexible assembly fixed on a lower surface of the movable assembly by an engaging material, wherein as observed from the direction that is perpendicular to the main axis, a portion of the engaging material overlaps the plane on which the surface of the fixed assembly is located while the movable assembly is closest to the fixed assembly.

9. The electromagnetic driving module as claimed in claim 1, wherein the electromagnetic assembly comprises:
a focusing driving coil; and
a magnetic element facing the focusing driving coil, wherein the focusing driving coil and the magnetic element are positioned on the movable assembly;
wherein as observed from the direction that is perpendicular to the main axis, a portion of the magnetic element overlaps the plane on which the surface of the fixed assembly is located while the movable assembly is moved along the path of travel.

10. A lens driving device, comprising:
a movable assembly;
a fixed assembly arranged on a main axis with the fixed assembly and having a surface facing the movable assembly;
an electromagnetic assembly configured to drive the movement of the movable assembly relative to the fixed assembly using magnetic force;
wherein as observed from a direction that is perpendicular to the main axis, a portion of the movable assembly that is closer to the main axis than the fixed assembly overlaps a plane on which the surface of the fixed assembly is located while the movable assembly is moved to at least a part of the path of travel; and
a lens assembly positioned in the movable assembly, wherein the optical axis of the lens assembly is aligned with the main axis.
